(19) United States
(12) Patent Application Publication
(10) Pub. No.: US 2021/0295416 A1
(43) Pub. Date: Sep. 23, 2021

(54) METHOD AND DEVICE FOR ORDERING ARTICLES

(71) Applicant: Henkel AG & Co. KGaA, Duesseldorf (DE)

(72) Inventors: Arnd Kessler, Monheim am Rhein (DE); Christian Nitsch, Duesseldorf (DE); Lars Zuechner, Langenfeld (DE); Georg Wawer, Wien (AT); Alexander Mueller, Monheim (DE)

(73) Assignee: Henkel AG & Co. KGaA, Duesseldorf (DE)

(21) Appl. No.: 16/318,072

(22) PCT Filed: Jul. 11, 2017
(86) PCT No.: PCT/EP2017/067335

§ 371 Date: Jan. 15, 2019

(30) Foreign Application Priority Data
Jul. 15, 2016 (DE) 10 2016 212 977.5

(51) Int. Cl. G06Q 30/06

(52) U.S. Cl. CPC G06Q 30/0633

(57) ABSTRACT

The present disclosure relates to, among other things, a method carried out by at least one device, said method including determining (410) information identifying an article (310, 320, 330); and ordering or triggering an order (450) of the article (310, 320, 330) at least partially based on the determined information identifying the article (310, 320, 330).

### CROSS-REFERENCE TO RELATED APPLICATION

This application is a U.S. National-Stage entry under 35 U.S.C. § 371 based on International Application No. PCT/EP2017/067335, filed Jul. 11, 2017 which was published under PCT Article 21(2) and which claims priority to German Application No. 10 2016 212 977.5, filed Jul. 15, 2016, which are all hereby incorporated in their entirety by reference.

### TECHNICAL FIELD

The present disclosure relates to methods and devices that can be used in the context of reordering different articles.

### BACKGROUND

Private households generally purchase a plurality of different consumer goods. Said consumer goods also include, for example, cleaning agents, in particular also washing agents. Studies have shown that the majority of consumers stay loyal to one manufacturer, one brand or one particular product over a long period. In other words, the consumers thus generally replace a used product with the same product.

The purchase of consumer goods of this kind, for example cleaning agents, is a necessity for the consumer, but generally of low interest since a new purchase merely replaces used products with identical new products. Depending on consumer habits, a purchase of this kind can take place daily or weekly, for example.

It is possible for the consumer to forget to purchase the relevant product since, although they may think of shopping when they use the product up, they may already have forgotten this when they go shopping for the first time after a delay in time, potentially days later. With the sometimes multitudinous variety of products found today, it is also possible that the consumer may not remember all the details of the product (manufacturer, type, fragrance, amount, size, etc.) and therefore may unintentionally buy another product.

In order to remedy this, it is known from the prior art to provide a device having a knob and a communication interface, the actuation of the knob triggering an ordering process of a specific, predefined product, which is specified on the label of the device, for example. However, a device is invariably associated with a product, meaning that actuating the knob triggers an ordering process always for the same product. If different products are to be ordered, a separate device is to be provided for each specific product. Even if the consumer does not want to stay loyal to the product on one occasion and wants to switch the product, a new device would need to be purchased. However, owing to the different devices to be provided, this is uneconomical and also impairs the usability.

Against this background, there is furthermore the need to make the purchase of articles easier for the consumer or user and to provide a high usability even in the event of reordering different products.

### BRIEF SUMMARY

Methods, devices, and computer-readable storage media are provided for ordering articles. In an embodiment, a method is implemented by at least one device. The method includes determining, with the at least one device, identification information of an article. The method further includes ordering or triggering an order of the article, with the at least one device, based at least in part on the determined identification information of the article.

In another embodiment, a device includes at least one processor and at least one memory that includes a computer program code, wherein the at least one memory and the computer program code are configured to carry out and/or control at least one method for ordering articles by employing the at least one processor. The at least one method for ordering articles includes determining identification information of an article and ordering or triggering an order of the article based at least in part on the determined identification information of the article.

### BRIEF DESCRIPTION OF THE DRAWINGS

The present disclosure will hereinafter be described in conjunction with the following drawing figures, wherein like numerals denote like elements, and wherein:

FIG. 1a shows a block diagram of an embodiment of an exemplary device as contemplated herein for carryingout an embodiment of an exemplary method as contemplated herein;

FIG. 1b is a schematic perspective view of the device from FIG. 1;

FIG. 2 is a schematic view of an embodiment of a cleaning device;

FIGS. 3a, 3b and 3c are schematic views of embodiments of different articles;

FIG. 4 is a flow chart of an embodiment of a method as contemplated herein; and

FIG. 5 shows different embodiments of a storage medium.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

The present disclosure addresses in particular the problem of making the purchase of articles and in particular the reordering of consumer goods easier for the user and to provide a high usability even in the event of reordering different products.

An exemplary method as contemplated herein, carried out by at least one device, is described, the method comprising: determining identification information of an article; and ordering or triggering an order of the article based at least in part on the determined identification information of the article.

Since identification information of the article is firstly determined by the at least one device and ordering or triggering of an order, based at least in part on the determined identification information, then takes place, the possibility is introduced of being able to order different articles by employing the same device since, owing to an upstream determination of the identification information of the article, it can first be determined what article is intended to be ordered. This is advantageous for the user since he does not require a separate device for each product. This is evident when using a cleaning device, for example. For a cleaning device (for example a washing machine or a dishwasher), a plurality of articles is generally required for operation; for example, in the case of a washing machine, a washing agent and a softener or, in the case of a dishwasher, a dishwasher detergent, a clear rinse and a salt, for example. By determining the identification information, customized ordering of the corresponding article or triggering of an order can then take place.

An article may comprise article contents and/or article packaging, for example. For example, the article is an article for daily use, the contents of which are intended for consumption or for being used up. For example, the article is used up by consumption. It is likewise conceivable for the article to be a commodity which is worn during use and needs to be repurchased.

The article contents can in particular be a cleaning agent, in particular a washing agent or (dishwashing) detergent. However, a cleaning agent is understood to be not only the agent effecting the actual cleaning, but rather also a cleaning auxiliary or cleaning admixture, for example a bleaching admixture, a softener, laundry starch, clear rinse or dishwasher salt. A cleaning agent may be a liquid, a disperse system, for example a gel or a foam, or a solid, in particular a tablet, powder or granulate. However, the article may also be another article, the article preferably being an article which can be used when using domestic appliances.

A cleaning agent may have one or more components from the group of components comprising surfactants, alkalis, builders, graying inhibitors, optical brighteners, enzymes, bleaching agents, soil release polymers, fillers, softeners, fragrances, dyes, nourishing agents, acids, starches, isomalt, sugar, cellulose, cellulose derivatives, carboxymethyl cellulose, polyetherimide, silicone derivatives and/or polymethylimines, for example. A cleaning agent may further comprise one or more additional components. Said components include but are not limited to the group of bleach activators, complexing agents, builders, electrolytes, non-aqueous solvents, pH adjusters, perfume carriers, fluorescing agents, hydrotropic substances, silicone oils, bentonites, anti-redeposition agents, anti-shrink agents, anti-crease agents, dye transfer inhibitors, fillers, antimicrobial active ingredients, germicides, fungicides, antioxidants, preservatives, corrosion inhibitors, antistatic agents, bittering agents, ironing aids, repellents and impregnating agents, anti-swelling and anti-slip agents, and UV absorbers.

The article may comprise article packaging for holding the article contents. The article packaging may simultaneously act as a storage container, for example. The article packaging may be designed to be resealable. The article packaging may be disposable packaging or refillable packaging. The article packaging is designed to hold solid and/or liquid article contents, for example. An item of article packaging is designed as a box, carton, cardboard packaging, pouch, bag, bottle or cartridge, for example. An item of article packaging includes (at least in part) cardboard, paper, a plastics material and/or film, for example. The article contents of an item of article packaging are sufficient for multiple use, for example. In the case of a cleaning agent, a plurality of cleaning processes can be carried out using the cleaning agent, for example.

Identification information of an article is understood in particular to be information (which can be provided in particular as data representing said information) which allows (in particular unique) identification of the article or an article group associated with the article. Identification information can in particular allow an article to be differentiated from other dissimilar articles. The identification information may be considered as a fingerprint of the article, for example.

Ordering or triggering an order may comprise in particular transmitting or triggering a transmission of order information. Order information of this kind may be representative of a user account, user information (for example login information), the article to be ordered, a number of the article to be ordered, a delivery address and/or a supplier, for example. The order information is sent, for example, to a server, for example a server of an (online) mail order company, and received thereby. The order can then be processed and the article can be delivered to the user.

Ordering or triggering the order of the article is thus understood in particular to mean that the (same) article whose identification information has been determined is ordered (or the order is triggered). However, in this case a quantity (for example a different filling quantity) of the same article, which quantity is different from the present article whose identification information has been determined, can be ordered, for example.

The article whose identification information has been determined can be considered in particular as a first article. The identification information can be referred to as a first item of identification information. However, the method as contemplated herein allows particular identification information of other articles (for example a second, third, fourth, etc., article) to be determined and then said article is ordered or the order is triggered.

The method can be carried out in particular by one or more of the exemplary devices described herein.

According to an embodiment of the exemplary method, the identification information is determined based at least in part on the contents of the article and/or packaging of the article.

In order to determine the identification information, the article contents and/or the article packaging or a feature thereof can be detected (at least in part). By determining the identification information based on the contents of the article and/or the packaging of the article, the identification information can be obtained in a user-friendly manner. In particular, the user has the article contents or the article packaging ready to hand during use, and therefore it can be particularly easily provided by the user for determining the identification information.

If the identification information is determined based on the article contents, this has the advantageous effect that the original article packaging is not required and that the user can decant the article contents, for example, and store said contents in packaging that is different from the original article packaging, for example. Since in particular cleaning agents are often filled into another storage container by the user for storage, the determination of the identification information is thus not impaired.

However, if the identification information is determined based on the article packaging, this has the advantageous effect that the identification information can be determined in the case of a consumed or used article.

As already explained, the article packaging can be formed in various ways and using various materials. In this case, the article packaging may be sales packaging, service packaging, secondary packaging or retail packaging, for example. The article packaging has a carrier, for example, which is detachably or permanently connected to the article packaging or is formed integrally therewith and based on which the identification information can be determined.

According to an embodiment of the exemplary method, the identification information of the article is determined using a sensor. A sensor may comprise one or more sensors, for example. A sensor may also comprise electronics for evaluating corresponding sensor signals from the particular sensor. Determining the identification information thus comprises in particular detecting the article or a part thereof. In this case, the sensor may be in particular an (integral or separate) part of a stationary device (for example of a domestic appliance) or a mobile device. In this case it is advantageous that the article does not need to be adapted or only needs to be adapted with little effort.

In this respect, a device for carrying out the exemplary method may be a sensor device, in particular a dedicated sensor device which can be used exclusively to reorder articles.

Alternatively, however, it is likewise conceivable for the identification information to be determined using a communication interface. For example, the communication interface is configured for wireless communication, for example using RFID technology. The communication interface may also be configured for communication using a wireless network (for example in accordance with the IEEE-802.11 standard, the Bluetooth (LE) standard and/or the NFC standard). The article then may comprises an (active or passive) RFID transponder, for example, in order to provide the identification information.

According to an embodiment of the exemplary method, the article or a part thereof for determining the identification information of the article is located at least temporarily in a sensing region of the sensor. The sensing region of the sensor is understood, for example, to mean the region surrounding the sensor in which the article or the part thereof for determining the identification information can be located. For example, the user brings the article or the corresponding part thereof into the sensing region of the sensor. If the article or the part thereof is located in the sensing region, the identification information can be determined (automatically or in a manually triggered manner) based on the article. In this case, the article located in the sensing region can be filled, partially filled or used up, for example.

A part of the article may be in particular a part of the article packaging. A part (for example a label or a sticker) that is detachable or removed from the remaining article packaging can be brought into the sensing region, for example. This has the advantage that neither the article contents nor the entire article packaging needs to be present.

According to an embodiment of the exemplary method, the sensor comprises one or more of the following sensors: an optical sensor, an inductive sensor, a magnetic field sensor, a capacitive sensor, and/or a gas sensor.

An optical sensor is understood in particular to mean an optoelectronic sensor. The optical sensor is configured, for example, to detect visible and/or invisible electromagnetic radiation. The optical sensor is configured, for example, to detect an absorption or emission of the article (for example an absorption and/or emission spectrum of the article packaging or the article contents). The optical sensor is configured, for example, to detect UV radiation, for example UV-A, UV-B and/or UV-C radiation. The sensor is configured, for example, to detect infrared radiation, for example NIR, MIR and/or FIR radiation. The optical sensor may comprise an image sensor, in particular a digital image sensor. The optical sensor may in particular comprise a semiconductor element, a (photo) diode and/or a CCD or CMOS element. The sensor may also optionally comprise a light-emitting diode. For example, the optical sensor comprises a spectrometer (for example a UV/VIS spectrometer). In this way, a corresponding feature of the article that is detectable by an optical sensor can be detected, and therefore identification information can be determined.

An inductive sensor has in particular one or more coils. With the aid of a resonant circuit (comprising a coil and a capacitor), the sensor emits an electromagnetic field. An article (in particular the article packaging) may have an electrically conductive material. If the article is moved past the sensor, i.e. in particular guided through the sensing region, this causes eddy currents. As a result the amplitude of the resonant circuit changes. For example, a (characteristic) damping or a (characteristic) change in frequency takes place. In this way, a corresponding feature of the article that is detectable by an inductive sensor can be detected, and therefore identification information can be determined.

A magnetic field sensor may be a magnetometer, for example. The magnetic sensor can detect a magnetic field (magnetic flux density), for example. A (characteristic) change in the magnetic field can be detected, for example. For example, a (characteristic) change in a magnetic field can be produced in a specific material, a semiconductor, a liquid, an optical waveguide and/or a thin layer. In this way, a corresponding feature of the article that is detectable by a magnetic field sensor can be detected, and therefore identification information can be determined.

A capacitive sensor comprises in particular one or more capacitors. For example, a capacitive sensor detects a change in the capacitance of the one capacitor or of a capacitor system. In this way, a corresponding feature of the article that is detectable by a capacitive sensor and characteristically changes the capacitance can be detected, and therefore identification information can be determined.

A gas sensor may be an electrochemical sensor, for example. The gas sensor is configured, for example, to detect odorants or odorant compositions. For example, the sensor detects the intensity, the temporal progression, the slope behavior and/or damping behavior. Since a gas sensor can often only detect one or few substances, it is advantageous to provide more than one gas sensor, for example a sensor array of various gas sensors. For example, an odor profile of the contents of an article (for example when the article packaging is opened) can be detected. For this purpose, the (opened) closure of the article packaging can be brought into the sensing region. The article contents may have, for example, one or more additives for creating a corresponding odor profile. However, the odor profile may likewise be created by the article contents themselves, which are present in any case. An odor profile of a part of the article packaging (for example of a (peelable) sticker or an adhesive tape) can be detected, for example. In this case, the odor profile may be perceptible to a person or imperceptible to a person. In this way, a corresponding feature of the article that is detectable by a gas sensor can be detected, and therefore identification information can be determined.

The sensor may also comprise a magnetoelastic sensor. A magnetoelastic sensor can measure a change in magnetic permeability when the length of a substance changes. By applying an oscillating magnetic field to a magnetizable material, a change in length occurs which in turn triggers an oscillation response, which can be evaluated.

According to an embodiment of the exemplary method, the identification information of the article is representative of at least one feature of the contents and/or the packaging of the article.

As already explained, in the case of identification information that is representative of a feature of the article contents, an advantage is that the original article packaging is not required to determine the identification information. In the case of identification information that is representative of a feature of the article packaging, this has the advantageous effect that the article contents are not required to determine the identification information and therefore the identification information can also be determined in the case of an article that has already been completely used up.

According to a preferred embodiment, the at least one feature of the contents and/or the packaging of the article may be a chemical and/or physical property.

A physical property may be, for example, a spectral property (for example a color, and absorption spectrum and/or an emission spectrum), a density, a thermal conductivity, an electrical conductivity, a magnetic permeability or remanence, a state of matter (solid, liquid, gaseous), an optical activity, a viscosity, a surface tension, a thermal capacity and/or an acoustic velocity. A chemical property may be, for example, an odor, a reactivity to various other substances, a pH, an acidity constant and/or a base constant. In order to determine a corresponding physical and/or chemical property of the article, a corresponding sensor or a corresponding sensor for detecting the corresponding physical and/or chemical property can be provided, and therefore corresponding identification information can be determined.

According to an embodiment of the exemplary method, the at least one feature of the article contents and/or the article packaging is one or more of the following features: a dimension; a volume; a silhouette; transparency; a color feature; a pattern; a font feature; and/or an optoelectronically readable font. It has been shown that, by employing individual or combinations of the mentioned features, it is possible to reliably determine identification information.

A dimension may be the (minimum, maximum or average) length, width and/or height of the article contents and/or the article packaging or a part thereof, for example.

The volume is understood to mean in particular the expansion or the space requirement of the article contents and/or the article packaging (or a part thereof), for example a total volume or a hollow volume.

A silhouette is understood to mean a contour or an outline of the article contents and/or the article packaging (or a part thereof), for example. The silhouette corresponds to the outline of a projection (for example a central projection) of the article contents and/or the article packaging or a part thereof, for example.

Transparency is understood to mean in particular the optical property of the article contents and/or the article packaging (or a part thereof) of allowing electromagnetic waves (in particular based on a specific wavelength range) to pass through.

A color feature may be, for example, one or more colors of the article contents and/or the article packaging (or a part thereof). A color feature may likewise be a specific color pattern of the article contents and/or the article packaging or a part thereof. A pattern of the article contents and/or the article packaging or a part thereof may also be, irrespective of the color thereof, a feature of the article contents and/or the article packaging or a part thereof, based on which the identification information can be determined.

A font feature is understood to mean the information represented or encoded by the font, for example. A font feature may also be a font type, an emphasis and/or font size. For example, identification information can be determined from a font feature by employing text identification or optical character recognition.

An optoelectronically readable font is understood in particular to be a font which can be read by machine and electronically processed. An optoelectronically readable font is a barcode, for example. An optoelectronically readable font may also be a 2D code.

According to an embodiment of the exemplary method, the identification information of the article is determined based at least in part on an in particular activatable carrier.

A carrier can have in particular one or more of the described features based on which the identification information can be determined. A carrier may be, for example, a label, a sticker or an adhesive tape which has or provides a corresponding feature (for example have a specific color, have a specific imprint, release a specific odor or have a specific electric or magnetic property). A transponder which carries digital information and can provide said information can likewise be considered as a carrier. The carrier may be in particular an (in particular integral) part of the packaging of the article.

Underlying the fact that the substrate is activatable, it is understood in particular that the identification information is not accessible or determinable before the activation since, for example, a feature of the article is not visible or not detectable, for example. The identification information is at least temporarily accessible or determinable only upon activation. A carrier may be activatable, for example, by a removable cover (e.g. a peelable sticker) being provided, such that the corresponding feature is only enabled when said cover is removed, i.e. for example the color or the imprint becomes visible or the odor is released. A carrier may also be activatable by an activatable electric circuit being activated, for example.

According to an embodiment of the exemplary method, the method further comprises identifying the article and/or an article group to be associated with the article, based on the identification information.

An identification of the article is understood to mean that an article can be identified as one article from identical articles, for example. For example, as part of the identification based on the determined identification information, an article number, an article name and/or an article manufacturer is determined (for example article “A” of manufacturer “X” or article “B” of manufacturer “Y”). The information determined by the identification of the article is preferably sufficient to order or to trigger the order of the article. An identification of an article group is understood to mean that an article group can be identified which can be associated with the article. For example, articles of one manufacturer, one type or one intended use form an article group, meaning that the article can be associated with an article manufacturer, an article type or an intended use by employing the identification information (for example an article for purpose C or an article of manufacturer Z or an article of type D).

According to an embodiment of the exemplary method, the identification of the article or the article group is based on a comparison of the identification information with reference information. In this respect, the method according to the first aspect can also in particular comprise a comparison of the identification information with reference information.

The reference information is of the same type as the identification information, for example. If the identification information is representative of a specific feature of the article, for example, then the reference information is also representative of a corresponding feature. The reference information can be recorded in a database as a dataset, for example. For example, the reference information is stored on a device, for example on a server. The reference information or datasets containing said information is/are received by a server, for example. A dataset may then comprise, for example, a plurality of items of reference information (for example reference data) and article information associated therewith in each case (for example an article number, an article name and/or an article manufacturer). If, for example, determined identification information is identical or (sufficiently) similar to an item of reference information, the article can be identified by employing the article data associated with the reference information.

According to an embodiment of the exemplary method, the method further comprises taking into account calibration information to determine the identification information.

Using the calibration information, in particular undesired influences can be reduced or eliminated when determining the identification information and an identification can be designed to be reliable in terms of process. For example, when detecting a color using an optical sensor, both the sensor used and the ambient light can have an effect on the determined identification information. Likewise, when detecting a dimension of an item of article packaging, the distance of the article from the optical sensor can be relevant. Effects of this kind can be reduced or eliminated by calibration information.

The calibration information can be determined, for example, based on a physical calibration object, for example based on a scale element or a color chart. If the calibration object is brought into the sensing region of the sensor before, during or after the identification information has been determined, for example, the calibration information can thus be determined. The calibration information is therefore determined, for example, by employing the same sensor and in particular by employing the same sensor by which the identification information is determined.

Alternatively, the calibration information can also be present or obtained (exclusively) electronically (for example in the form of calibration data). If it is known from the calibration data, for example, that a font used on the article packaging has a specific size, a dimension of the article packaging can be concluded therefrom without a physical scale element needing to be used.

According to an embodiment of the first aspect, the calibration information is preferably determined based on the article. If the calibration information is provided by the article (for example by the article packaging), a separate calibration object such as a color chart or a scale element is not required. In particular, the calibration information can be considered to be an integral component of the article packaging. For example, rather than a (separate) color chart or rather than a (separate) scale element, the colors for calibration or the scale for calibration can be applied to the article packaging (for example as part of the label). In this case, the calibration information, similarly to as described in connection with the identification information, can likewise be provided by an activatable carrier, for example can be arranged under a removable cover.

According to an embodiment of the exemplary method, the method further comprises: determining quantity information; determining supplier information; and/or determining address information. This can further individualize the ordering process and make said process more user-friendly.

The quantity information is representative of the quantity of the article to be ordered, for example. The quantity information can be predefined by the user, for example (for example by the number of actuations of a control element). Alternatively, the quantity information can be determined or suggested on the basis of historical data (of the user).

The supplier information is representative of the supplier who supplies the order, for example. The supplier information can be predefined by the user, for example (for example by employing a control element). Alternatively, the supplier information can be determined or suggested on the basis of historical data (of the user).

The address information is representative of the delivery address of the article or articles to be ordered, for example. The address information can be predefined by the user, for example (for example by employing a control element). Alternatively, the address information can be determined or suggested on the basis of position information (for example representative of a position of the device which carries out an exemplary method). The position information is determined, for example, on the basis of a communication network, for example on the basis of a wireless network such as a mobile network (for example a GSM network). The position information is determined, for example, on the basis of a global navigation satellite system (for instance Naystar GPS, GLONASS or Galileo). For this purpose, corresponding signals from the system or network can be received and evaluated.

According to an embodiment of the exemplary method, the method further comprises: determining at least one second item of identification information of a second article (which is in particular different from the first article); and ordering or triggering an order of the second article based on the determined second item of identification information of the second article.

The previously described article and the identification information can in this respect be considered to be a first article or first item of identification information. Since a second item of identification information of a second article is determined, the second article can advantageously be ordered (or said order can be triggered). The method thus allows the possibility of being able to order not just one product but also different products in a user-friendly manner. The previous explanations and described embodiments relating to the first article and the first item of identification information are also to be understood as disclosed in relation to the second article and the second item of identification information.

According to an embodiment of the exemplary method, the method further comprises: associating at least one order of a first article and one order of a second article. For example, the order of the first article and the order of the second article are grouped by the association. For example, the order of the first article and the order of the second article can be considered to be a bulk order. A joint ordering or triggering of an order can thus take place in a bulk order of the first and second article, for example.

An order of a first article and an order of a second article are associated, for example, when the weight of the articles reaches or exceeds a predefined weight, when the value of the articles reaches or exceeds a predefined value and/or when the volume of the articles reaches or exceeds a predefined value.

It is likewise possible for the process of repeatedly obtaining and/or determining the identification information to be used for machine learning. Machine learning is understood to mean that an artificial system (for example a device according to the second aspect or a system according to the third aspect) learns from examples, and can generalize said examples following the learning phase. This means that it does not simply learn the examples by heart, but that patterns and regularities are recognized in the learning data. Various approaches can be taken for this purpose. For example, supervised learning, semi-supervised learning, unsupervised learning, reinforcement learning and/or active learning can be used. Supervised learning can, for example, be carried out by employing an artificial neural network (such as a recurrent neural network) or by employing a support vector machine. In addition, unsupervised learning can, for example, be carried out by employing an artificial neural network (for example an autoencoder). For example, in particular the repeatedly obtained and/or determined identification information can then be used as learning data.

Alternatively or additionally, it is conceivable for obtained and/or determined identification information to be associated with other information, for example with the number and/or the age of the person in a household in order to produce a personal usage profile, or for example with the seasons in order to produce a seasonal usage profile.

According to an embodiment of the exemplary method, the article is a cleaning agent article, in particular a washing agent article.

As already explained, for a cleaning device such as a washing machine or a dishwasher, a plurality of articles are generally required for operation (washing agent and softener or dishwasher detergent, clear rinse and salt). However, the method can be carried out using only one additional device (possibly in addition to devices that are present in any case such as a cleaning device or a mobile device), even though different articles need to be ordered.

An exemplary device as contemplated herein is additionally described which is configured or comprises corresponding features to carry out and/or to control an exemplary method as contemplated herein.

Another exemplary device as contemplated herein comprises at least one processor and at least one memory comprising computer program code, the at least one memory and the computer program code being configured to carry out and/or control at least one exemplary method as contemplated herein by employing the at least one processor. A processor should be understood to mean, for example, a control unit, a microprocessor, a microcontrol unit such as a microcontroller, a digital signal processor (DSP), an application-specific integrated circuit (ASIC) or a field programmable gate array (FPGA).

An exemplary device further comprises, for example, features for storing information, such a program memory and/or a main memory. An exemplary device as contemplated herein further comprises, for example, features for respectively receiving and/or transmitting information over a network, such as a network interface. Exemplary devices are and/or can be interconnected via one or more networks, for example.

An exemplary device is or comprises, for example, a data-processing system configured using software and/or hardware in order to execute the respective steps of an exemplary method. The data processing system may be a cleaning device or a part thereof, for example. Further examples of a data-processing system are a computer, a desktop computer, a server, a thin client and/or a portable computer (mobile device), such as a laptop computer, a tablet computer, a wearable, a personal digital assistant or a smartphone.

According to an embodiment of an exemplary device, the device comprises a user interface, a communication interface, and/or a sensor for determining the identification information of the article. An exemplary device which comprises at least one sensor may be referred to in particular as a sensor device. A sensor device of this kind preferably has a mobile design.

A user interface is or comprises a control element, in particular a switch or a button, for example. For example, this may be the only control element of the device. In particular, an exemplary device can be designed to be screen-free. An exemplary device can be designed to be integral with or separate from a domestic appliance.

For example, the communication interface of an exemplary device is configured for wireless or wired communication with a domestic appliance.

An exemplary computer program as contemplated herein is additionally described which comprises program instructions that prompt a processor to execute and/or control an exemplary method as contemplated herein when the computer program runs on the processor.

An exemplary computer-readable storage medium as contemplated herein is additionally described which contains an exemplary computer program as contemplated herein.

An exemplary system as contemplated herein is additionally described, the system comprising a plurality of devices, in particular comprising an exemplary device as contemplated herein, which devices together are configured to carry out an exemplary method as contemplated herein.

For example, the system comprises a sensor device and in addition another device, for example a domestic appliance, a mobile device (for example a smartphone) and/or a server.

If the sensor device comprises at least one communication interface which allows communication with a domestic appliance and enables Internet access, the sensor device can advantageously make a non-web-enabled device (for example a non-web-enabled domestic appliance) web-enabled. For this purpose, the sensor device can be connected to the non-web-enabled device in a wireless or wired manner and in addition can be connected to the Internet in a wireless or tethered manner. In this respect, the sensor device can act as an access point or base station.

Individual method steps, which do not necessarily need to be carried out by the sensor device, for example, can be performed by another device which is connected, in particular by employing a communication system, to the device comprising the sensor. Another device of this kind may be provided, for example a server and/or for example a part or component of a computer cloud, which provides data-processing resources dynamically for different users in a communication system. A computer cloud is understood to mean in particular a data-processing infrastructure in accordance with the definition from the National Institute for Standards and Technology (NIST) for the term “cloud computing.” One example of a computer cloud is a Microsoft Windows Azure platform.

An example of a domestic appliance is a cleaning device, for example a washing machine or a dishwasher. However, other domestic appliances are also conceivable in principle, for example a tumble dryer or a kitchen appliance, for example a refrigerator.

The washing machine may have various different designs. A distinction is made between top-loading washing machines, in which the loading opening is on the top, and front-loading washing machines, in which a porthole on the front serves as the loading opening. An advantage of top-loading washing machines is that it is easier to construct the door seal and the drum can be supported on two sides by roller bearings, and a top-loading washing machine can also be positioned in very small spaces where there is not enough space to open a front door. By contrast, a front-loading washing machine provides space on top for e.g. a tumble dryer or for a worktop, and is therefore sometimes built into a kitchen unit instead of a floor unit. Top-loading washing machines are disadvantageous since they require a greater volume of water for washing laundry than front-loading washing machines.

American top-loading washing machines always have a rotating drum and mixing elements (agitators or discs), with the mixing elements being able to move in or counter to the rotational direction of the drum. The machines may comprise a suds circulator and injectors for the suds. In principle, a distinction is made between deep-fill and HE top-loading washing machines. Deep-fill top-loading washing machines operate at a predefined water level, and therefore do not use any load detection. HE washing machines generally have load detection and control the quantities of water in accordance therewith. Generally, the machines do not have an integrated heater, but instead are connected to a hot water feed.

The exemplary embodiments of the present disclosure described above in this description are also intended to be understood to be disclosed in any combination with one another. In particular, exemplary embodiments are intended to be understood to be disclosed in relation to different aspects.

In particular, by way of the preceding or following description of method steps according to preferred embodiments of a method, corresponding features for carrying out the method steps are also intended to be disclosed by preferred embodiments of a device. Likewise, the disclosure of use of a device for carrying out a method step is also intended to disclose the corresponding method step.

Further advantageous, exemplary embodiments of the present disclosure are found in the following detailed description of some exemplary embodiments of the present disclosure, in particular in conjunction with the drawings. The drawings are, however, only provided for illustrative purposes, and do not serve to define the scope of protection of the present disclosure. The drawings are not to scale and are merely intended to provide an example of the general concept of the present disclosure. In particular, features contained in the drawings are not in any way intended to be considered as necessary components of the present disclosure.

Detailed Description of Some Exemplary Embodiments of the Present Disclosure

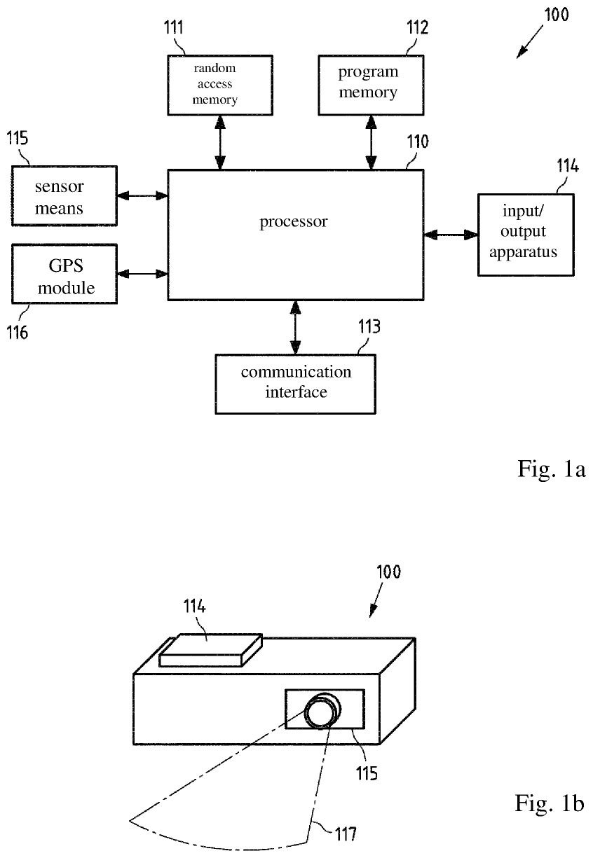

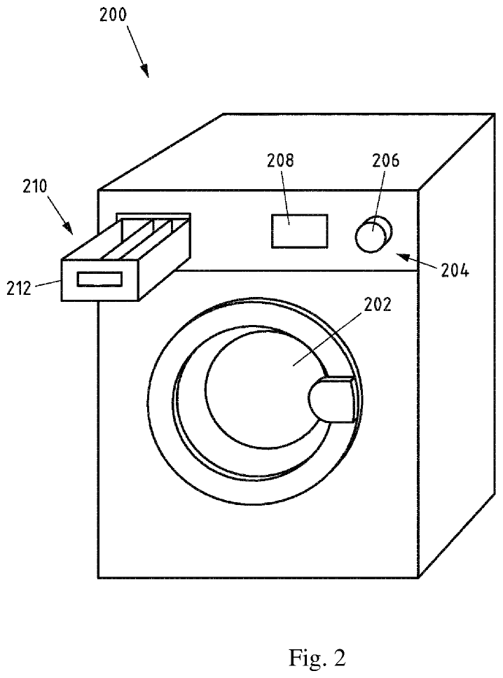

FIG. 1a shows a block diagram of an embodiment of an exemplary device 100 as contemplated herein for carrying out an embodiment of an exemplary method as contemplated herein (or at least parts thereof). FIG. 1b is a perspective view of an exemplary embodiment of the device 100 from FIG. 1a as a separate mobile sensor device. However, the device 100 may also be designed as a cleaning device or as part thereof or may be integrated therein, for example. However, the device 100 may also be a computer, a desktop computer or a portable computer (mobile device), for instance a laptop computer, a tablet computer, a personal digital assistant (PDA) or a smartphone. The device can fulfil the function of a server or a client, for example.

The sensor device 100 has in particular a sensor 115, which may comprise one or more sensors. A corresponding sensor is configured to determine identification information of articles. In this example, the sensor 115 comprises an optical camera as the sensor. Alternatively or additionally, however, other sensors described herein may in principle also be provided. FIG. 1b additionally shows a sensing region 117 of the sensor 115. Identification information can be determined based on an article that is located in the sensing region 117.

The device further comprises a GPS module 116 which can determine signals from a global navigation satellite system (for instance Naystar GPS, GLONASS or Galileo), in order to determine position information of the sensor device 100. Alternatively or additionally, however, position information can be determined on the basis of signals from a communication interface (for example communication interface 113).

The sensor 115 and the GPS module 116 of the sensor device 100 can be controlled by processor 110 or can communicate therewith.

Processor 110 of the sensor device 100 is in particular designed as a microprocessor, microcontrol unit, microcontroller, digital signal processor (DSP), application-specific integrated circuit (ASIC) or a field programmable gate array (FPGA).

Processor 110 executes program instructions stored in the program memory 112, and stores for example intermediate results or the like in working or main memory 111. For example, the program memory 112 is a non-volatile memory such as a flash memory, a magnetic memory, an EEPROM memory (electrically erasable programmable read-only memory) and/or an optical memory. Main memory 111 is, for example, a volatile or non-volatile memory, in particular a random access memory (RAM), such as a static RAM memory (SRAM), a dynamic RAM memory (DRAM), a ferroelectric RAM memory (FeRAM) and/or a magnetic RAM memory (MRAM).

Program memory 112 is preferably a local data carrier that is rigidly connected to the sensor device 100. Data carriers that are rigidly connected to the sensor device 100 are, for example, hard disks that are built into the sensor device 100. Alternatively, the data carrier may for example also be a data carrier that can be separably connected to the sensor device 100, such as a memory stick, a removable data carrier, a portable hard disk, a CD, a DVD and/or a floppy disk.

Program memory 112 contains, for example, the operating system of the sensor device 100, which system is, at least in part, loaded into main memory 111 and executed by the processor 110 when the sensor device 100 is started. In particular, when the sensor device 100 is started, at least part of the kernel of the operating system is loaded into the main memory 111 and executed by processor 110. The operating system of sensor device 100 is, for example, a Windows, UNIX, Linux, Android, Apple iOS and/or MAC operating system.

The operating system makes it possible in particular to use the sensor device 100 for data processing. Said system manages, for example, resources such as main memory 111 and program memory 112, communication interface 113, input and output apparatus 114, provides, inter alia by employing programming interfaces of other programs, basic functions and controls the execution of programs.

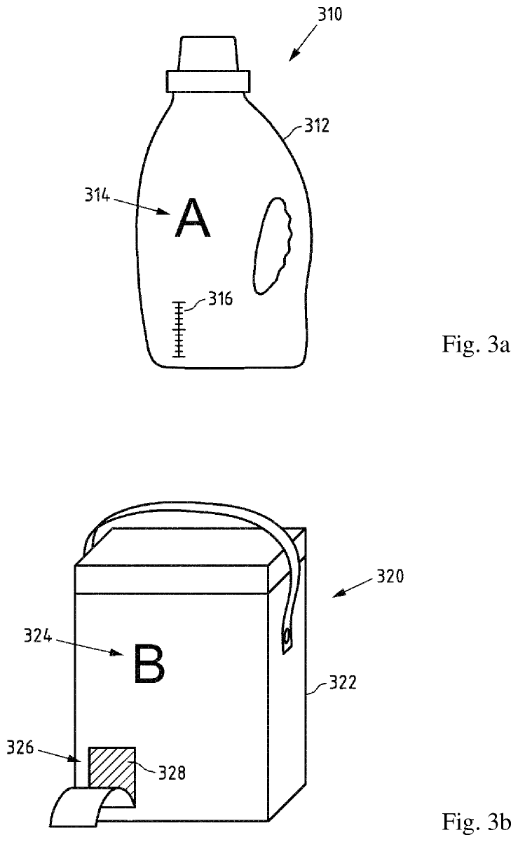

Processor 110 additionally controls the communication interface 113, which may be a network interface, for example, and can be designed as a network card, network module and/or modem. The communication interface 113 is in particular configured to establish a connection between the sensor device 100 and other devices, in particular by employing a (wireless) communication system, for example a network, and to communicate with said devices. The communication interface 113 can, for example, receive data (via the communication system) and forward said data to processor 110 and/or receive data from processor 110 and transmit said data (via the communication system). Examples of a communication system are a local network (LAN), a wide area network (WAN), a wireless network (for example in accordance with the IEEE-802.11 standard, the Bluetooth (LE) standard and/or the NFC standard), a wired network, a mobile network, a telephone network, and/or the Internet. For example, the sensor device 100 can communicate with the Internet and/or with a cleaning device (for example washing machine 200 in FIG. 2) by employing the communication interface 113.

Moreover, processor 110 can control at least one input/output apparatus 114. Input/output apparatus 114 is, for example, a keypad, a mouse, a display unit, a microphone, a touch-sensitive display unit, a loud speaker, a reader, a disk drive and/or a camera. Input/output apparatus 114 can, for example, record input from a user and forward said input to processor 110 and/or receive and output information for the user from processor 110. By way of example, FIG. 1b shows an input apparatus 114 in the form of a button. By employing the button, a user can enable and/or confirm an order or a triggering of an order by employing the sensor device 100.

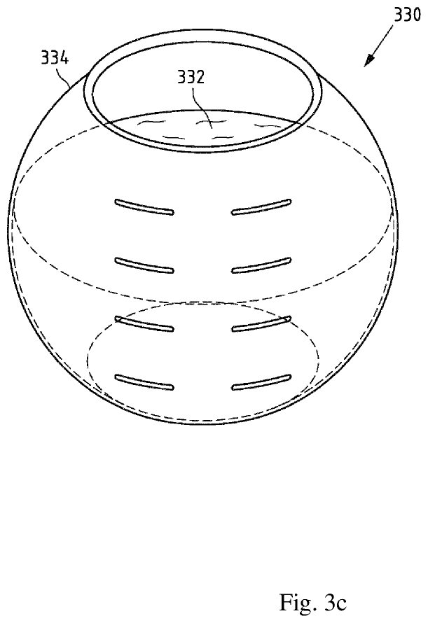

FIG. 2 shows an exemplary cleaning device 200. The cleaning device 200 may also be an embodiment of an exemplary device as contemplated herein and can in particular carry out embodiments of the method or parts thereof. For this purpose, the sensor device 100 or parts thereof may be integrated in the cleaning device 200. Alternatively, the cleaning device 200 may be configured to communicate with the sensor device 100 in a wired or wireless manner. The cleaning device 200 is in this case an automatic domestic washing machine for textiles, which machine is designed as a drum-type washing machine in which a washing drum 202 rotates about a horizontal axis (front-loading washing machine). However, the use of other types of cleaning devices is also conceivable. In addition to the drum 202, the washing machine 200 comprises user interfaces 204 in the form of a control element 206 and a display element 208. The control element 206 is designed as a rotary knob and can be used to set various washing parameters, for example the washing program and the washing temperature. The display element 208 can display information visually to the user. However, the washing machine 200 may also have additional user interfaces. The washing machine 200 further comprises a flushing-in feature 210 which comprises a detergent drawer 212. Said drawer is used to receive a cleaning agent. Corresponding articles are shown in FIG. 3a-c.

FIG. 3a-c are schematic views of embodiments of different articles. The article 310 shown in FIG. 3a comprises at least one item of article packaging 312 of a cleaning agent article (for example a washing agent article). Based on a feature of the article packaging 312, identification information can be determined. A possible feature of the article packaging 312 is the font feature 314 of the article packaging 312, for example. The article 310 can be identified as cleaning agent A by employing said feature. However, the dimension or the silhouette of the article packaging 312 could also be used as a feature for determining the identification information. For this purpose, based on the article packaging 312, calibration information can be determined. A scale 316 is printed on the article packaging such that corresponding calibration information can be determined based on the article 310. Said information can then be taken into account, for example, when determining identification information which is representative of the dimensions of the article packaging 312.

The article 320 shown in FIG. 3b comprises at least one item of article packaging 322 of a cleaning agent (for example a washing agent article). Based on a feature of the article packaging 322, identification information can be determined. As for the article packaging 312, a possible feature for determining the identification information based on the article packaging 322 is the font feature 324. As a result, the article 310 can be identified as cleaning agent B. The identification information can also be determined based on the activatable carrier 326. The carrier 326 can be activated by removing a sticker. As a result of this, a feature 328 of the article packaging 322 can be made available, for example a specific color can be made visible. As a result, identification information which is representative of a color of the article packaging 322 can be determined. It is also conceivable for a specific odorant to be provided by employing the activation. As a result, identification information which is representative of a chemical property in the form of an odor of the article packaging 322 can be determined.

The article contents are not required to determine the identification information as described in FIG. 3a or 3b.

The article 330 shown in FIG. 3c comprises at least one item of article contents 332 of a cleaning agent article (for example a washing agent article). This is filled into a dosing aid 334. Identification information can be determined based on a feature of the article contents 332. A possible feature for determining the identification information based on the article contents 332 is, for example, a chemical or physical property of the article contents 332, for instance an odorant or a specific color. As a result, identification information which is representative of the corresponding chemical or physical property of the article packaging 332 can be determined. The article packaging is not required to determine the identification information as described in FIG. 3c.

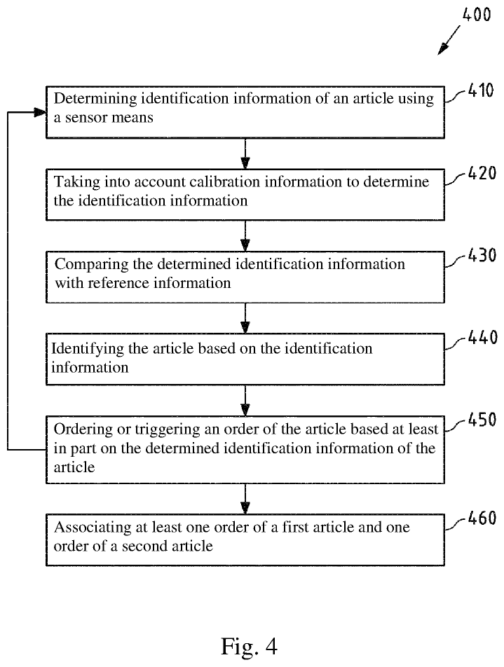

FIG. 4 now shows a flow chart 400 of an embodiment of a method as contemplated herein.

First an article (for example article packaging 312, 322 or article contents 332) is brought into a sensing region (for example sensing region 117 of the sensor 115 of the sensor device 100).

As a result, identification information of an article can be determined (action 410). In this case, the identification information is representative of a feature of the article contents (for instance article contents 332) or the article packaging (for instance article packaging 312, 322). In this case, calibration information (for example also obtained by the sensor 115, for example determined based on the scale 316) can be taken into account (action 420).

The determined identification information is compared with reference information (action 430). As a result and thus based on the identification information of the article, the article can be identified (action 440).

Since the article has now been identified based on the determined identification information, the article can be ordered or such an order can be triggered (action 460).

The described actions (actions 410-450) can be repeated for a second, third, fourth, etc., article.

In particular, an order of a first article (for example article “A” from FIG. 3a) and an order of a second article (for example article “B” from FIG. 3b) can be associated with each other such that the order takes place in a bulk order.

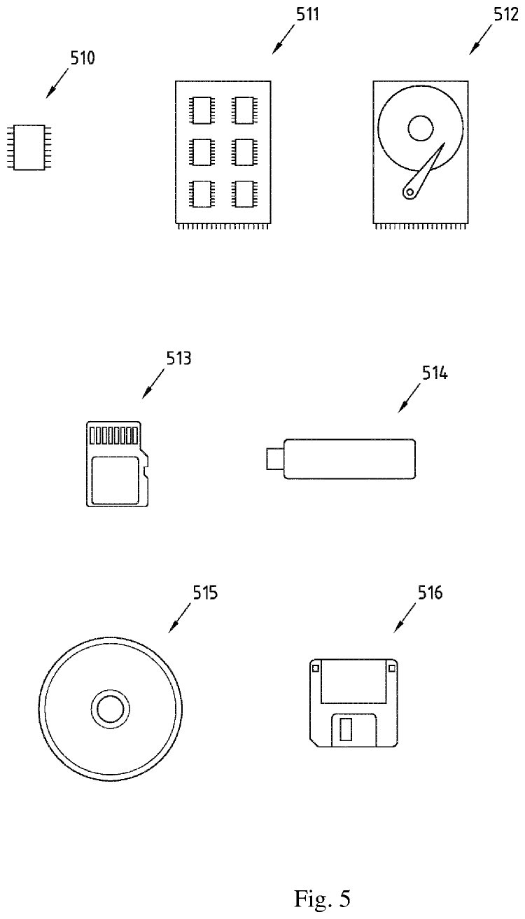

Finally, FIG. 5 shows different embodiments of storage media on which an embodiment of a computer program as contemplated herein can be stored. The storage medium may be, for example, a magnetic, electrical, optical and/or different storage medium. The storage medium may be, for example, part of a processor (e.g. the processor 110 in FIG. 1a), for example a (non-volatile or volatile) program memory of the processor or a part thereof (such as program memory 112 in FIG. 1a). Embodiments of a storage medium are a flash memory 510, an SSD hard disk 511, a magnetic hard disk 512, a memory card 513, a memory stick 514 (e.g. a USB stick), a CD-ROM or DVD 515 or a floppy disk 516.

The embodiments of the present disclosure described in the present specification and the optional features and properties mentioned with respect thereto in each case are also intended to be understood to be disclosed in any combination with one another. In particular, the description of a feature comprised by an embodiment, unless explicitly stated otherwise, is not intended in the present case to be understood to mean that the feature is necessary or essential for the function of the embodiment. The sequence of the method steps in the individual flow charts outlined in the present specification is not compulsory; alternative sequences of the method steps are conceivable. The method steps can be implemented in different ways; a software implementation (by employing program instructions), hardware implementation or a combination of the two for implementing the method steps is thus conceivable.

The terms such as “comprise,” “have,” “include,” “contain” and the like used in the claims do not exclude other elements or steps. The wording “at least in part” covers both “in part” and “completely.” The wording “and/or” is intended to be understood to mean that both the alternative and the combination are intended to be disclosed, i.e. “A and/or B” means “(A) or (B) or (A and B).” The use of the indefinite article does not exclude a plurality. A single device can carry out the functions of a plurality of the units or devices mentioned in the claims. The reference signs specified in the claims are not to be considered to limit the features and steps used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method implemented by at least one device, the method comprising:
determining, with the at least one device, identification information of an article; and
ordering or triggering an order of the article, with the at least one device, based at least in part on the determined identification information of the article.

2. The method according to claim 1, wherein the identification information is determined, with the at least one device, based at least in part on the contents of the article and/or packaging of the article.

3. The method according to claim 1, wherein the identification information of the article is determined using a sensor of the at least one device.

4. The method according to claim 3, wherein the article or a part thereof for determining the identification information of the article is located at least temporarily in a sensing region of the sensor.

5. The method according to claim 3, wherein the sensor comprises one or more of the following sensors:
an optical sensor;
an inductive sensor;
a magnetic field sensor;
a capacitive sensor; and/or
a gas sensor.

6. The method according to claim 1, wherein the identification information of the article is representative of at least one feature of the article contents and/or the packaging of the article.

7. The method according to claim 6, wherein the least one feature of the article contents and/or the packaging of the article is a chemical and/or physical property.

8. The method according to claim 6, wherein the least one feature of the article contents and/or the packaging of the article is one or more of the following features or comprises:
a dimension;
a volume;
a silhouette;
transparency;
a color feature;
a pattern;
a font feature; and/or
an optoelectronic readable font.

9. The method according to claim 1, wherein the identification information of the article is determined based at least in part on an activatable carrier.

10. The method according to claim 1, the method further comprising:
identifying the article and/or an article group to be associated with the article, with the at least one device and based on the identification information.

11. The method according to claim 10, wherein the identification of the article or the article group with the at least one device is based on a comparison, with the at least one device, of the identification information with reference information.

12. The method according to claim 1, the method further comprising:
taking into account calibration information to determine the identification information with the at least one device.

13. The method according to claim 12, wherein the calibration information is determined, with the at least one device, based on the article.

14. The method according to claim 1, the method further comprising:
determining quantity information, with the at least one device;
determining supplier information, with the at least one device; and/or
determining address information, with the at least one device.

15. The method according to claim 1, the method further comprising:
determining, with the at least one device, at least one second item of identification information of a second article; and
ordering or triggering an order of the second article, with the at least one device, based on the determined second item of identification information of the second article.

16. The method according to claim 1, the method further comprising:
associating, with the at least one device, at least one order of a first article and at least one order of a second article.

17. The method according to claim 1, wherein the article is a cleaning agent article.

18. (canceled)

19. A device comprising at least one processor and at least one memory comprising computer program code, wherein the at least one memory and the computer program code are configured to carry out and/or control at least one method according to claim 1 by employing the at least one processor.

20. The device according to claim 19, further comprising:
a user interface;
a communication interface configured for wireless or wired communication with a domestic appliance; and/or
a sensor means for determining the identification information of the article.

21. (canceled)

22. (canceled)

23. A computer-readable storage medium, that is a physical object, which comprises program instructions that prompt a processor to execute and/or control a method according to claim 1.

24. (canceled)
